(19) United States
(12) Patent Application Publication
(10) Pub. No.: US 2026/0001773 A1
(43) Pub. Date: Jan. 1, 2026

(54) METHOD FOR MANUFACTURING SODIUM BICARBONATE AND GYPSUM USING SODIUM SULFATE

(71) Applicant: RESEARCH INSTITUTE OF INDUSTRIAL SCIENCE & TECHNOLOGY, Pohang-si, Gyeongsangbuk-do (KR)

(72) Inventors: Jung-Gi MIN, Pocheon-si, Gyeonggi-do (KR); Young-Chul BYUN, Gwangyang-si, Jeollanam-do (KR); Young-Bong LEE, Gwangyang-si, Jeollanam-do (KR); Hoon-Ha LEE, Pohang-si, Gyeongsangbuk-do (KR); Dong-Jun KOH, Pohang-si, Gyeongsangbuk-do (KR)

(73) Assignee: RESEARCH INSTITUTE OF INDUSTRIAL SCIENCE & TECHNOLOGY, Pohang-si, Gyeongsangbuk-do (KR)

(21) Appl. No.: 18/870,725

(22) PCT Filed: Jun. 21, 2022
(86) PCT No.: PCT/KR2022/008767

§ 371 Date: Sep. 11, 2025

(30) Foreign Application Priority Data
Jun. 2, 2022 (KR) 10-2022-0067637

(51) Int. Cl. C01F 11/46; C01D 7/00

(52) U.S. Cl. CPC C01F 11/468; C01D 7/00; C01P 2002/72; C01P 2006/80

(57) ABSTRACT

The present disclosure relates to a method for producing sodium bicarbonate and gypsum using sodium sulfate.

### TECHNICAL FIELD

The present disclosure relates to a method for producing sodium bicarbonate and gypsum using sodium sulfate.

### BACKGROUND ART

Flue gas desulfurization refers to removing sulfur(S) components, especially sulfur dioxide (SO₂), from exhaust gases emitted from steel mills, thermal power plants, or the like. With the development of industry, harmful gases such as sulfur oxides (SOₓ) emitted from various factories, thermal power plants, and incinerators may cause serious air pollution and cause various diseases such as respiratory diseases, asthma, and lung cancer in the human body. Desulfurizing agents currently used in steel mills include sodium bicarbonate (NaHCO₃), activated carbon, and calcium hydroxide (Ca(OH)₂), and in particular, sodium bicarbonate is known to exhibit excellent adsorption efficiency when sprayed on a high-temperature exhaust gas since a specific surface area thereof is maximized. In this case, a waste of sodium sulfate (Na₂SO₄) is generated as a by-product of a desulfurization treatment.

Recently, as electric vehicles are becoming more widespread, demand for lithium, a raw material for secondary batteries, is increasing. Main by-products generated during lithium production are silica (SiO₂) and sodium sulfate (Na₂SO₄). It is expected that an amount of the by-product of sodium sulfate will also increase in line with the increasing demand for lithium to be described later. Therefore, the development of technology for recycling sodium sulfate should essentially be performed in advance for the spread of secondary batteries.

The by-products currently generated are dissolved in water and are then treated as wastewater or are buried as they are, which causes both treatment costs and secondary environmental problems. An effective method to utilize sodium sulfate, a by-product, is to dissolve sodium sulfate in water and regenerate the same into sodium bicarbonate by adding carbon dioxide and ammonia.

The technology underlying the present method is the Solvay method, and in the Solvay method, sodium bicarbonate is produced as a by-product in the middle of producing sodium carbonate and calcium chloride using concentrated seawater brine. However, since the Solvay method does not include a process for treating sulfate (SO₄²⁻), there is a need for the development of customized technology to solve the problem described above. Currently, it is predicted that an amount of generation of sodium sulfate will continue to increase. Therefore, there is an urgent need to find methods to recycle or reuse a by-product such as sodium sulfate.

### SUMMARY OF INVENTION

### Technical Problem

An aspect of the present disclosure to provide a method for manufacturing sodium bicarbonate and gypsum using a sodium sulfate-containing material, thereby enabling an environmentally friendly treatment of a sodium sulfate waste, and at the same time, manufacturing sodium bicarbonate using carbon dioxide, thereby satisfying the technology required for a carbon-neutral society.

### Solution to Problem

According to an aspect of the present disclosure, provided is a method for manufacturing sodium bicarbonate and gypsum, the method including: a first solid-liquid separation operation for producing a sodium sulfate solution containing sodium ions from a mixture of an eluent and a sodium sulfate-containing material, and recovering the sodium sulfate solution; a second solid-liquid separation operation for producing sodium bicarbonate (NaHCO₃) by adding carbon dioxide and ammonia to the sodium sulfate solution, and recovering the sodium bicarbonate; a third solid-liquid separation operation for producing low-purity gypsum having an SO₃ content of less than 40 wt % by adding a calcium-containing material to the filtrate remaining after the sodium bicarbonate is recovered, and recovering the low-purity gypsum; an ammonia recovery operation for producing ammonia by heating the filtrate remaining after the low-purity gypsum is recovered, and recovering the ammonia; and a high-purity gypsumization operation for adding sulfuric acid and the low-purity gypsum recovered from the third solid-liquid separation operation to the filtrate remaining after the ammonia is recovered.

An operation for recovering high-purity gypsum having an SO₃ content of 40 wt % or more may be additionally performed following the high-purity gypsumization operation.

A mass ratio of the sodium sulfate-containing material and the eluent added in the first solid-liquid separation operation may be 1:1.4 to 1:3.

A molar ratio of ammonia (NH₃)/sodium (Na⁺) in the second solid-liquid separation operation may be 0.8 to 1.3.

A pH in the second solid-liquid separation operation may be maintained at 7.5 to 9.0.

The second solid-liquid separation operation may further include a sodium bicarbonate washing operation for washing the sodium bicarbonate to increase a recovery rate of the sodium bicarbonate.

A washing solution used in the sodium bicarbonate washing operation may be recycled as the eluent in the first solid-liquid separation operation.

After the sodium bicarbonate washing operation, a sodium bicarbonate drying operation for drying the sodium bicarbonate may be further included.

### Advantageous Effects of Invention

As set forth above, according to an embodiment of the present disclosure, sodium sulfate-containing minerals, sodium sulfate by-products, and sodium sulfate-containing materials, which are desulfurization wastes generated by steel mills or power plants, may be used to produce sodium bicarbonate, and liquid wastes may be used to produce gypsum, thus reducing a disposal cost of wastes generated after desulfurization, carbon dioxide may be stably fixed as carbonate, thus having a carbon neutral contribution effect as CCU technology for using carbon dioxide.

According to another embodiment of the present disclosure, low-purity gypsum having a low SO₃ content may be refined into high-purity gypsum having a high SO₃ content, thus increasing a utilization value of gypsum.

### BRIEF DESCRIPTION OF DRAWINGS

FIG. 1 is a schematic diagram illustrating a method for manufacturing sodium bicarbonate and gypsum according to an embodiment of the present disclosure.

FIG. 2 is a graph illustrating the form of carbon dioxide present in a solution depending on a pH when carbon dioxide is dissolved.

FIG. 3 is a graph illustrating a change in a recovery rate of sodium bicarbonate in a desulfurization waste according to a mass ratio of water/sodium sulfate-containing material and a molar ratio of NH₃/Na⁺ in a second solid-liquid separation operation.

FIG. 4 is a graph illustrating a change in purity of sodium bicarbonate according to a molar ratio of NH₃/Na⁺ in the second solid-liquid separation operation.

FIG. 5A is a graph illustrating a change in purity of sodium bicarbonate according to an amount of water supplied in a sodium bicarbonate washing operation.

FIG. 5B is a graph illustrating purity of sodium bicarbonate after a sodium bicarbonate washing operation using an XRD pattern.

FIG. 6A is a graph illustrating an SO₃ content (XRF) of gypsum according to an amount of quicklime (CaO) slurry added in a third solid-liquid separation operation.

FIG. 6B is a graph illustrating a temperature change rate according to an amount of quicklime (CaO) slurry added according to a reaction time in a third solid-liquid separation operation.

FIG. 7 is a graph illustrating an ammonia recovery rate according to a temperature of quicklime (CaO) slurry in a third solid-liquid separation operation.

FIG. 8 is a graph illustrating an ammonia recovery rate according to a pH of quicklime (CaO) slurry in a third solid-liquid separation operation.

FIG. 9A is a graph illustrating an SO₃ content (XRF) of gypsum according to an amount of sulfuric acid added.

FIG. 9B is a graph illustrating XRD analysis results of gypsum according to an amount of sulfuric acid added.

### MODE FOR INVENTION

Hereinafter, preferred embodiments will be described with reference to the accompanying drawings. However, the spirit of the present disclosure is not limited to the presented examples. For example, a person skilled in the art who understands the spirit of the present disclosure may suggest other embodiments included in the scope of the spirit of the present disclosure through the addition, change, or deletion of elements, which is also included within the scope of the spirit of the present disclosure. The shapes and sizes of elements in the drawings may be exaggerated for clarity.

The present disclosure relates to a method for manufacturing sodium bicarbonate (NaHCO₃) and gypsum (CaSO₄), and more particularly, to a method for manufacturing sodium bicarbonate and gypsum having a carbon neutral contribution effect as CCU technology for using carbon dioxide, by recovering sodium (Na) from a low-purity sodium sulfate-containing material such as a sodium sulfate-containing waste, natural mineral, or the like, to produce sodium bicarbonate, producing high-purity gypsum from a SO₄²⁻ waste liquid to reduce a disposal cost of the waste generated after desulfurization, and stably fixing carbon dioxide as carbonate.

According to an embodiment of the present disclosure, a method for manufacturing sodium bicarbonate and gypsum may be provided. The method including: a first solid-liquid separation operation (S2) for producing a sodium sulfate solution containing sodium ions from a mixture of an eluent and a sodium sulfate-containing material, and recovering the sodium sulfate solution; a second solid-liquid separation operation (S5) for producing sodium bicarbonate (NaHCO₃) by adding carbon dioxide and ammonia to the sodium sulfate solution, and recovering the sodium bicarbonate; a third solid-liquid separation operation (S7) for producing low-purity gypsum having an SO₃ content of less than 40 wt % by adding a calcium-containing material to the filtrate remaining after the sodium bicarbonate is recovered, and recovering the low-purity gypsum; an ammonia recovery operation (S8) for producing ammonia by heating the filtrate remaining after the low-purity gypsum is recovered, and recovering the ammonia; and a high-purity gypsumization operation (S9) for adding sulfuric acid and the low-purity gypsum recovered from the third solid-liquid separation operation (S7) to the filtrate remaining after the ammonia is recovered.

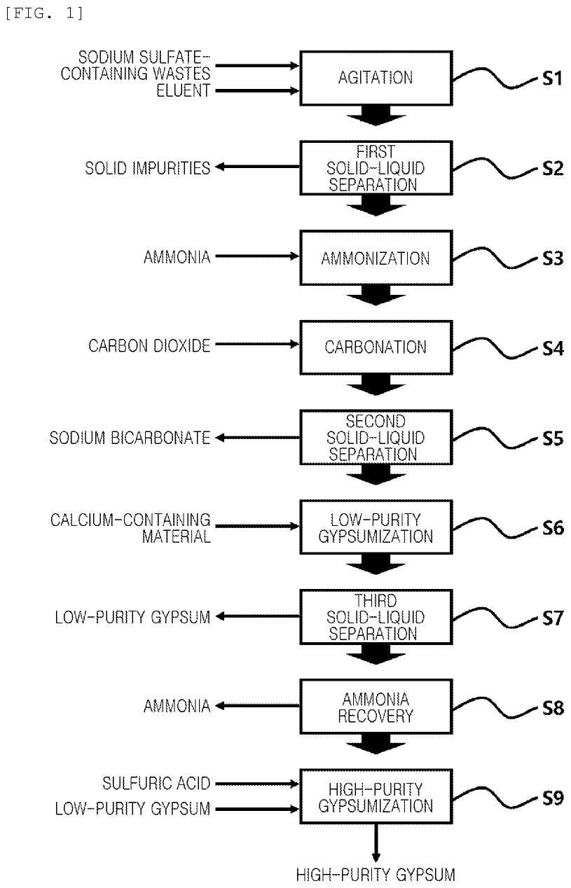

FIG. 1 is a schematic diagram illustrating a method for manufacturing sodium bicarbonate and gypsum according to an embodiment of the present disclosure. The present disclosure may include a first solid-liquid separation operation (S2), a second solid-liquid separation operation (S5), a third solid-liquid separation operation (S7), and an ammonia recovery operation (S8).

The first solid-liquid separation operation (S2) is an operation for producing a sodium sulfate solution containing sodium ions from a mixture of an eluent and a sodium sulfate-containing material, and recovering the sodium sulfate solution. The first solid-liquid separation operation (S2) may further include an agitation operation (S1) of mixing a sodium sulfate-containing material and an eluent prior to the separation operation. Since the eluent contains almost no sodium ions, a sodium sulfate solution may be easily produced from a sodium sulfate-containing material.

The sodium sulfate-containing material added in the first solid-liquid separation operation (S2) may be a low-purity sodium sulfate-containing material such as a sodium sulfate-containing waste or natural mineral. For example, the sodium sulfate-containing waste may be generated by desulfurizing flue gas containing sulfur oxide (SOₓ) components, or may be a waste generated as a by-product in a lithium production plant. For example, the sodium sulfate-containing waste may be generated by desulfurizing flue gas generated by combustion in thermal power plants, factories, and incinerators, or flue gas that has been electrostatically treated in a steel mill sintering plant using sodium bicarbonate. The sodium sulfate-containing waste may include impurities such as K, Ca, Fe, and Cl in addition to sodium sulfate, and the solid impurities generated after the agitation may be removed in the first solid-liquid separation operation (S2).

The eluent is not particularly limited as long as it is a material that can elute sodium sulfate ions when combined with a sodium sulfate-containing material, but may be, for example, one or more selected from water, an aqueous sodium solution, and an aqueous ammonia solution.

The second solid-liquid separation operation (S5) is an operation for producing sodium bicarbonate (NaHCO₃) using a sodium sulfate solution. The second solid-liquid separation operation (S5) may be performed subsequently by including an ammonification operation (S3) of adding ammonia to a sodium sulfate solution and a carbonation operation (S4) of adding carbon dioxide.

The sodium sulfate solution may react with carbon dioxide and ammonia to produce solid sodium bicarbonate through a carbonation reaction of the following Equation 1.

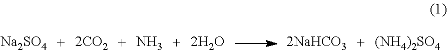

As shown in Equation 1 above, Gibbs' free energy of a reaction producing calcium carbonate is a negative number of −851.0 KJ/mol, so the reaction producing sodium bicarbonate can occur spontaneously. In addition, since such a reaction is an exothermic reaction, it has the advantage of not consuming much additional energy during the sodium bicarbonate production process.

A reaction pressure of a carbonation reactor in which the carbonation reaction occurs may be 1 to 10 atm, and a reaction temperature may be 50° C. or lower. When the pressure of the carbonation reactor exceeds 10 atm, a sufficient amount of carbon dioxide may be dissolved, but energy required for the carbonation reactor is high, which may reduce the economic feasibility of sodium bicarbonate and gypsum, which are final products. The time for the carbonation reaction varies depending on the method of injecting carbon dioxide. If carbon dioxide is injected in the form of gas, it varies depending on whether aeration is performed or not, and if aeration is performed, it can take less than 4 hours. However, the optimized pressure and reaction time may depending vary on the size/space/conditions of the reactor.

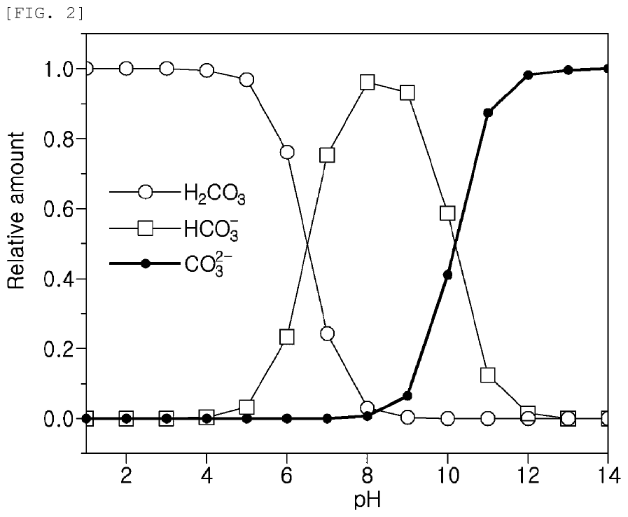

FIG. 2 is a graph illustrating the form of carbon dioxide present in a solution depending on a pH when carbon dioxide is dissolved. A Formula of sodium bicarbonate, also called sodium bicarbonate, is NaHCO₃, and the production of sodium bicarbonate may increase as a concentration of bicarbonate ions (HCO₃⁻) among the components of the sodium sulfate solution increases.

In addition, referring to FIG. 2, the concentration of bicarbonate ions in an aqueous solution of a carbonate system containing carbon dioxide is the highest when the pH is 7.5 to 9.0. Therefore, in order to increase the recovery rate of sodium bicarbonate, it is preferable to maintain the pH of the sodium sulfate solution at 7.5 to 9.0.

However, if a sufficient amount of carbon dioxide is dissolved in the sodium sulfate solution to produce the sodium bicarbonate, the pH of the solution may be lowered to 7.5. In this case, bicarbonate ions (HCO₃⁻) are converted to carbonic acid (H₂CO₃), which may reduce a rate of sodium bicarbonate production. Therefore, it is preferable to first add ammonia and sufficiently dissolve the ammonia before adding carbon dioxide to the sodium sulfate solution.

The carbon dioxide may be at least one selected from the group consisting of pure carbon dioxide, FINEX off gas (FOG), FINEX tail gas (FTG), blast furnace gas (BFG), converter gas, coal power plant flue gas, gas power plant flue gas, incinerator flue gas, glass melting flue gas, thermal facility flue gas, petrochemical process flue gas, petrochemical process gas, pre-combustion flue gas, and gasifier flue gas.

In addition, the carbon dioxide may be concentrated by one or more methods selected from the group consisting of a wet amine process, a PSA process, and a membrane process.

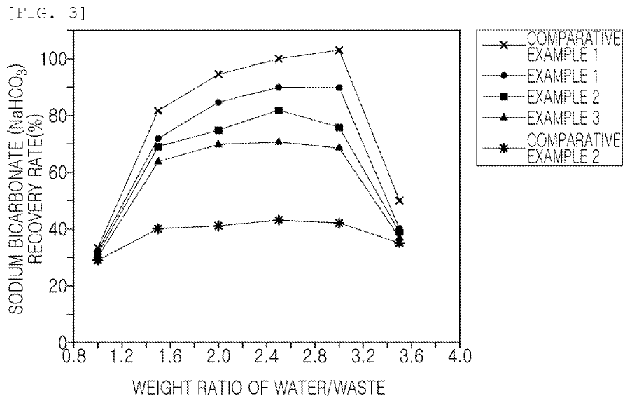

FIG. 3 is a graph illustrating a change in a recovery rate of sodium bicarbonate in a desulfurization waste according to a weight ratio of water/sodium-containing material and a molar ratio of NH₃/Na⁺ in a second solid-liquid separation operation.

Referring to FIG. 3, the recovery rate of sodium bicarbonate may be adjusted by controlling a mass ratio of the sodium sulfate-containing material and water, which is an eluent, added in the first solid-liquid separation operation (S2). In order for the recovery rate of the sodium bicarbonate recovered in the second solid-liquid separation operation (S5) to be 50% or more (based on Na⁺ moles), the mass ratio of the sodium sulfate-containing material and the eluent added in the first solid-liquid separation operation (S2) may be 1:1.4 to 1:3. If the mass ratio of the eluent to the sodium sulfate-containing material is less than 1.4, there may be a problem in which sodium sulfate is not dissolved, resulting in loss of sodium sulfate as residue, thereby reducing a recovery rate of sodium ions. If the mass ratio of the eluent to the sodium sulfate-containing material exceeds 3, the recovery rate of sodium ions increases, but there may be a problem in that the concentration of sodium ions is low, so the reaction does not proceed, and the content of sodium ions leaking out the waste liquid increases, thereby lowering the production of sodium bicarbonate.

Meanwhile, in order to recover 50 mol % of sodium bicarbonate based on the Na+ molar concentration, a molar ratio of ammonia (NH₃)/sodium (Na⁺) in the waste solution is preferably 0.8 to 1.3. If the molar ratio of ammonia (NH₃)/sodium (Na⁺) is less than 0.8, the recovery rate of sodium bicarbonate recovered in the second solid-liquid separation operation (S5) is less than 50 mol %, and if the molar ratio of ammonia (NH₃)/sodium (Na⁺) exceeds 1.3, the recovery rate of sodium bicarbonate increases, but the purity of sodium bicarbonate may decrease.

Since the sodium bicarbonate separated in the second solid-liquid separation operation (S5) is manufactured using a sodium sulfate-containing material containing impurities, purity of sodium bicarbonate is lower than that of the sodium bicarbonate manufactured using pure sodium sulfate. Therefore, in order to increase the purity of sodium bicarbonate, the second high-liquid separation operation (S5) may include a sodium bicarbonate washing operation for washing sodium bicarbonate. As the amount of washing in the sodium bicarbonate washing operation increases, the purity of the produced sodium bicarbonate may be improved.

The washed sodium bicarbonate may further include a sodium bicarbonate drying operation. Since the sodium bicarbonate drying operation is performed at a temperature exceeding 50° C., the sodium bicarbonate tends to be decomposed again into sodium carbonate, so it is preferable that the sodium bicarbonate be dried at 50° C. or lower.

However, if a final target product is sodium carbonate, other than sodium bicarbonate, the produced sodium bicarbonate may be dried at 50° C. or higher to obtain sodium carbonate. In addition, the solution used for washing to improve the purity of sodium bicarbonate may be recycled as the eluent in the first solid-liquid separation operation (S2).

The third solid-liquid separation operation (S7) is an operation for producing low-purity gypsum generated by the filtrate remaining after the sodium bicarbonate is recovered, and recovering the low-purity gypsum. The third solid-liquid separation operation (S7) may include a low-purity gypsumization operation (S6) producing low-purity gypsum having an SO₃ content of less than 40 wt % by adding a calcium-containing material to the sodium bicarbonate. Since the filtrate from the carbonation reaction above contains a large amount of sulfate ions (SO₄²⁻), a calcium-containing substance may be added to manufacture the sulfate ions contained in the filtrate into gypsum.

The calcium-containing material may be at least one selected from the group consisting of waste cement, waste concrete, coal ash, fly ash, iron ore slag, quicklime (CaO), calcium chloride (CaCl₂)), wollastonite, limestone, olivine, serpentine, asbestos, and deinking ash.

When a calcium-containing substance is added to the filtrate optimized to a pH of 7.5 to 9.0 to produce the sodium bicarbonate, the pH of the filtrate increases to 9 or more. When the pH of the filtrate becomes 9 or more, the carbon dioxide remaining in the solution is present in the form of carbonate ions (CO₃²⁻), so the added calcium ions (Ca²⁺) react with the carbonate ions to produce calcium carbonate (CaCO₃). In addition, carbon dioxide remaining in the solution at a high pH level forms slaked lime (Ca(OH)₂) by hydroxide groups (OH⁻) in water. Therefore, the gypsum produced in the third solid-liquid separation operation (S7) contains calcium carbonate and calcium hydroxide, and is low-purity gypsum having an SO₃ content of less than 40 wt %.

The ammonia recovery operation (S8) is an operation for producing ammonia by heating the filtrate remaining after low-purity gypsum is recovered and recovering the ammonia. The filtrate remaining after extracting the low-purity gypsum contains a large amount of ammonia, so it is preferable to recover the ammonia. If a slurry including low-purity gypsum is added into an ammonia recovery device of the ammonia recovery operation (S8), the slurry may be attached thereto in a scale state, which may reduce efficiency. Therefore, ammonia can be recovered efficiently only when ammonia is added in an aqueous solution state.

In this case, the molar ratio of calcium ions and sulfate ions (Ca²⁺:SO₄²⁻) is preferably 1:1.0 to 1.3, and when a ratio of sulfate ions exceeds 1.3, the purity of gypsum decreases. When the ratio of sulfate ions is less than 1.0, there is a problem that the pH of the filtrate is too low and ammonia cannot be sufficiently recovered in an ammonia stripping operation.

It is preferable that the pH of the ammonia recovery operation (S8) be maintained at 8.0 or higher. If the pH of the ammonia recovery operation (S8) is less than 8.0, there is a problem that the ammonia recovery rate is lowered.

In addition, in the ammonia recovery operation (S8), the remaining filtrate is heated, and the heated filtrate is preferably 50° C. or higher. If the temperature of the filtrate is lower than 50° C., there is a problem that the ammonia recovery rate is lowered.

Before the ammonia recovery operation (S8), an exothermic reaction occurs in the third solid-liquid separation operation (S7) due to a reaction between calcium-containing materials and water. Therefore, by adding a heat exchanger between the sodium bicarbonate reactor and the ammonia recovery device, additional energy consumption may be reduced by applying heat to the ammonia recovery device, thereby saving energy in the ammonia recovery operation.

The recovered ammonia may be reused in the form of gas or remanufactured into ammonia water and then reused.

The high-purity gypsum operation (S9) is an operation in which ammonia is recovered, and sulfuric acid and low-purity gypsum recovered in the third solid-liquid separation operation are added to the filtrate to produce high-purity gypsum having an SO₃ content of 40 wt % or more. In the ammonia recovery operation (S8), if the recovered low-purity gypsum is mixed again in the filtrate remaining after ammonia and sulfuric acid are recovered is additionally injected, the pH of the filtrate drops. When the pH of the filtrate drops, carbonate ions present in the filtrate are converted to hydrogen carbonate ions, thereby inhibiting the production of calcium carbonate, and the reduction of hydroxide ions in the solution also reduces slaked lime, thereby obtaining high-purity gypsum with an SO₃ content of 40 wt % or more.

After the high-purity gypsum operation, an operation for recovering high-purity gypsum having an SO₃ content of 40 wt % or more may be additionally performed.

In this case, a ratio of sulfate ions added from calcium ions and sulfuric acid (Ca²⁺:SO₄²⁻) is preferably 1:0.1 to 0.5, and if the ratio of sulfate ions exceeds 1:0.5, the pH may be too low, thereby increasing the cost of wastewater treatment. When the ratio of sulfate ions is less than 1:0.1, the SO₃ content is insufficient and the sulfate ion cannot be used as commercial gypsum.

In addition, the sulfate ions included in the sulfuric acid may also act as a raw material for gypsum.

In the third solid-liquid separation operation (S7), high-purity gypsum may be recovered, and the filtrate may be discharged after a wastewater treatment.

Hereinafter, the present disclosure will be described more specifically through specific examples. The following examples are merely examples to help understand the present disclosure, and the scope of the present disclosure is not limited thereto.

### EXAMPLE

### Experimental Example 1: Measurement of Changes in a Recovery Rate and Purity of Sodium Bicarbonate in a Desulfurization Waste According to a Mass Ratio of Water/Sodium Sulfate-Containing Material and a Molar Ratio of NH₃/Na+

After adding water and a sodium sulfate-containing material in different ratios in an agitator, agitation was performed at 40° C. for 1 hour at an agitation speed of 500 rpm, and solid-liquid separation of a mixture thereof after the agitation has been performed to obtain a sodium sulfate solution.

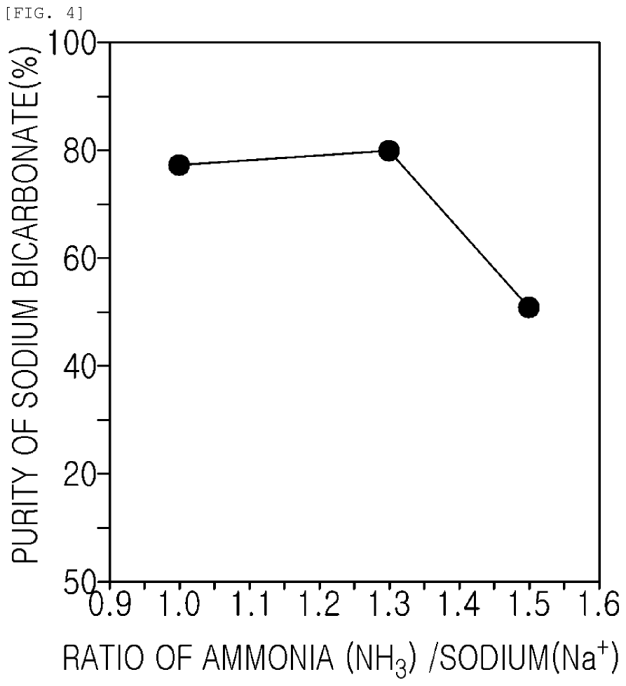

Thereafter, the sodium sulfate solution and an ammonia aqueous solution containing 25 to 30 wt % ammonia were added to a 300 mL high-pressure reactor at a ratio shown in Table 1 below and agitated. While maintaining a temperature of the high-pressure reactor at 25° C., carbon dioxide gas was injected at 7 bar. In the high-pressure reactor, agitation was performed at an agitation speed of 200 rpm for 8 hours, and the solid and liquid separation was performed on a product that has been agitated through filtering again to obtain sodium bicarbonate. A recovery rate of the obtained sodium bicarbonate according to a weight ratio of water/wastes and a molar ratio of NH₃/Na⁺ was measured, and the results were shown in FIG. 3. The purity of sodium bicarbonate according to the molar ratio of NH₃/Na⁺ was measured using an ion chromatograph (IC), and the results were shown in FIG. 4.

TABLE 1

| | MOLAR RATIO OF NH₃:Na⁺ |
|---|---|
| EXAMPLE 1 | 1.3 |
| EXAMPLE 2 | 1.0 |
| EXAMPLE 3 | 0.8 |
| COMPARATIVE EXAMPLE 1 | 1.5 |
| COMPARATIVE EXAMPLE 2 | 0.6 |

According to FIG. 3, in Examples 1 to 3 in which a molar ratio of NH₃:Na⁺ is 0.8 or more, it can be confirmed that a recovery rate of sodium bicarbonate exceeds 50% when a weight ratio of water/waste is in the range of 1.4 to 3, but in Comparative Example 2 in which the molar ratio of NH₃:Na⁺ is less than 0.8, it can be confirmed that the recovery rate of sodium bicarbonate is 50% or less.

In addition, according to FIG. 4, when producing sodium bicarbonate according to Comparative Example 1 in which the molar ratio of NH₃/Na⁺ exceeds 1.3, it can be confirmed that a content of impurities such as (NH₄)₂SO₄ or the like, increases and the purity of sodium bicarbonate decreases to less than 80%.

### Experimental Example 2: Measurement of Purity of Sodium Bicarbonate According to an Amount of Water Used in a Sodium Bicarbonate Washing Operation

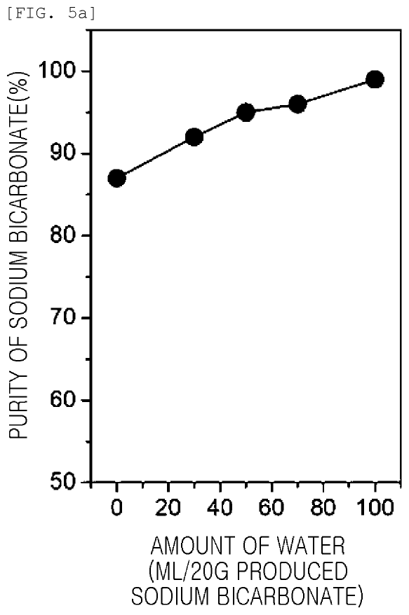

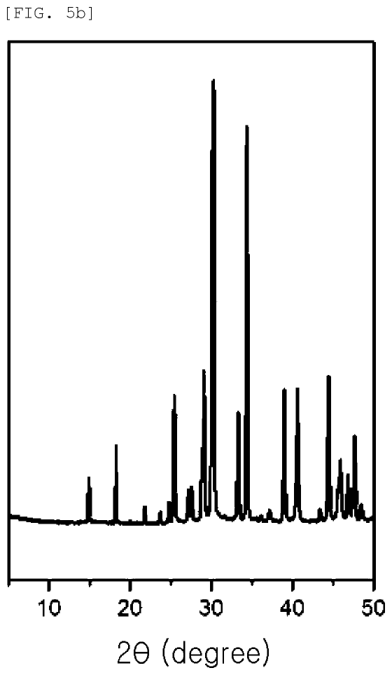

Sodium bicarbonate manufactured in the same manner as in Experimental Example 1 was washed and dried. A change in the purity of sodium bicarbonate was measured by varying an amount of water supplied during a washing operation using ion chromatography (IC), and the results were shown in FIG. 5A.

In addition, the purity of sodium bicarbonate after washing with 83 mL of water supplied in the washing operation was measured using an X-ray diffraction analyzer (XRD), and the results are shown in FIG. 5B.

According to FIG. 5A, it can be confirmed that the purity of sodium bicarbonate increases as the amount of water supplied in the washing operation increases.

### Experimental Example 3: Measurement of Purity of Gypsum and Reaction Temperature According to an Amount of Quicktime Slurry Added

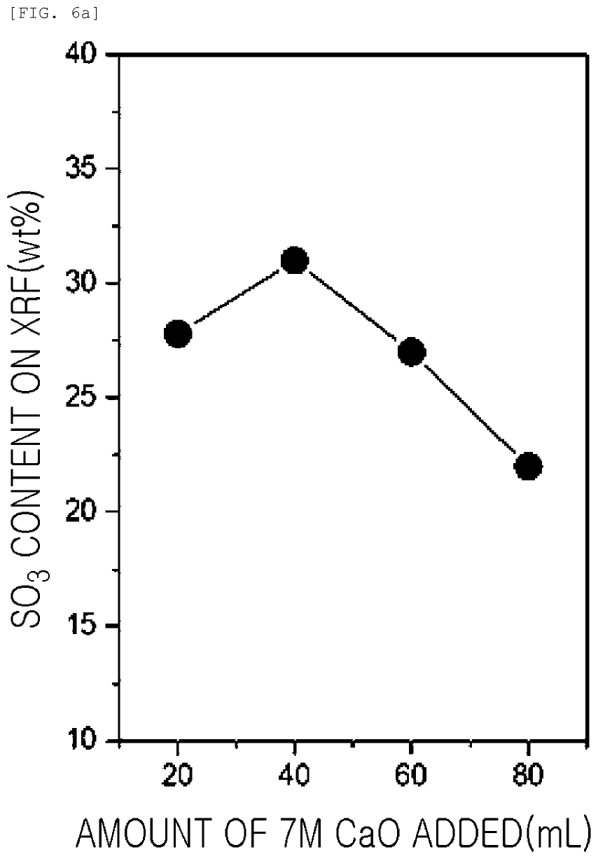

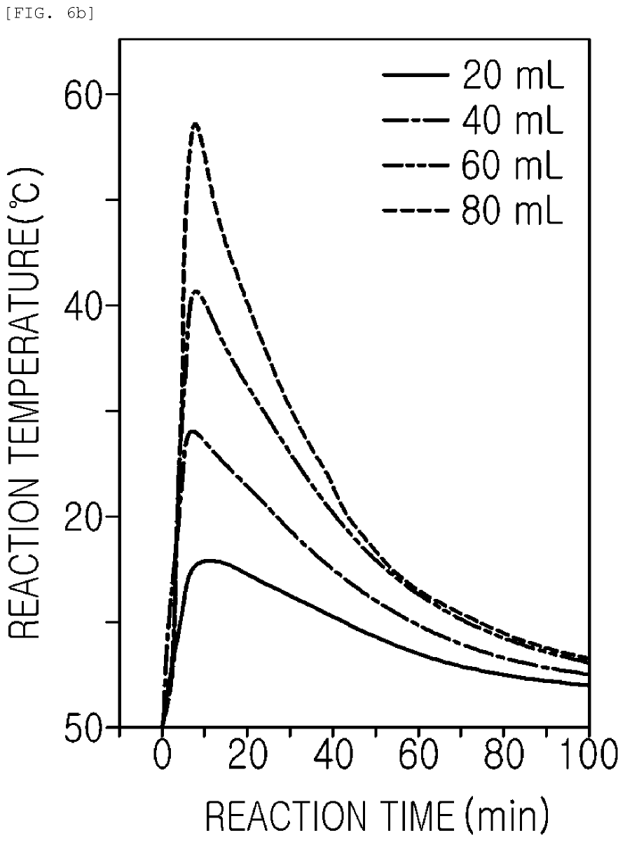

After carbonation, 100 mL of a waste solution and 20, 40, 60, and 80 mL of 7 M quicklime slurry were manufactured, and then added to a gypsum reactor, agitated for 30 to 60 minutes, and third solid-liquid separation was performed to recover gypsum. The recovered gypsum was dried, and then the purity and yield of gypsum were measured. The purity of quicklime was confirmed through a SO₃ content of XRF, and the results were shown in FIG. 6A. In addition, when manufacturing a quicklime slurry, an exothermic reaction occurs, and a change in a temperature of a solution containing the quicklime slurry was shown in FIG. 6B.

According to FIG. 6A, when an amount of quicklime slurry added exceeds 40 mL, a pH of the gypsum increases and the SO₃ content decreases.

According to FIG. 6B, it could be confirmed that as the amount of quicklime slurry added increased, the temperature of the reaction solution increased.

### Example 4: Measurement of an Ammonia Recovery Rate According to Temperature

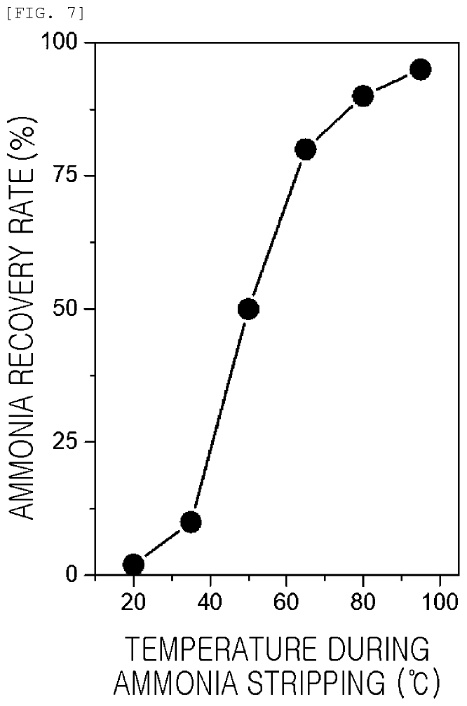

After carbonation, 100 mL of a waste solution was added in a gypsum reactor, 40 mL of 7 M quicklime was added, and then reacted at room temperature for 30 to 60 minutes and gypsum was removed through third solid-liquid separation. The filtrate remaining after manufacturing gypsum was added in an ammonia recovery device, and then a heating temperature was varied in the range of 20 to 95° C. and aerated with nitrogen. An ammonia recovery rate was confirmed through IC, and the results were shown in FIG. 7.

According to FIG. 7, it could be confirmed that the ammonia recovery rate increased as the temperature increased.

### Experimental Example 5: Measurement of an Ammonia Recovery Rate According to a pH of Filtrate Remaining after Gypsum Extraction

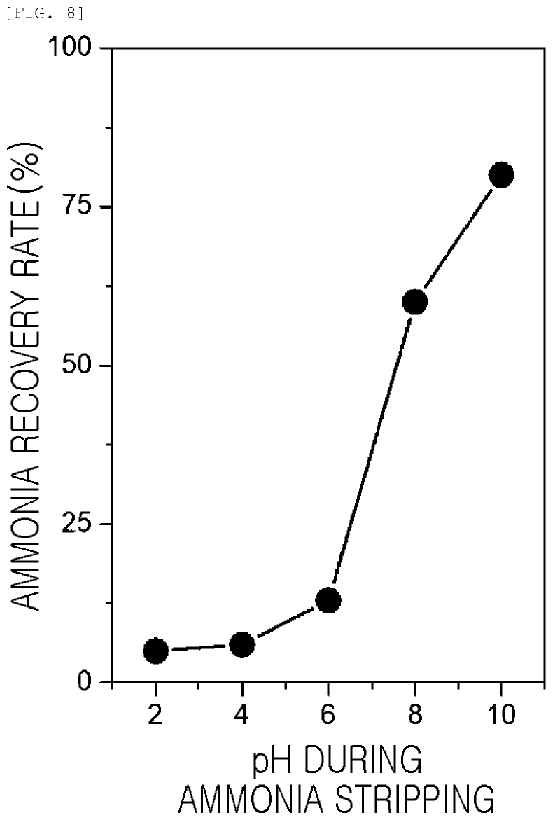

After recovering gypsum, a pH was adjusted by adding H₂SO₄ to the filtrate, to lower the pH or increase the pH by using a 7 M quicklime slurry, and then ammonia was recovered. A temperature was maintained at 85° C. during ammonia recovery. The ammonia recovery method was the same as that illustrated in Example 5, and the results of ammonia recovery rate were shown in FIG. 8.

According to FIG. 8, it can be confirmed that the ammonia recovery rate increases as the pH of the residue increases.

### Experimental Example 6: Measurement of Purity of Gypsum by Adding Sulfuric Acid

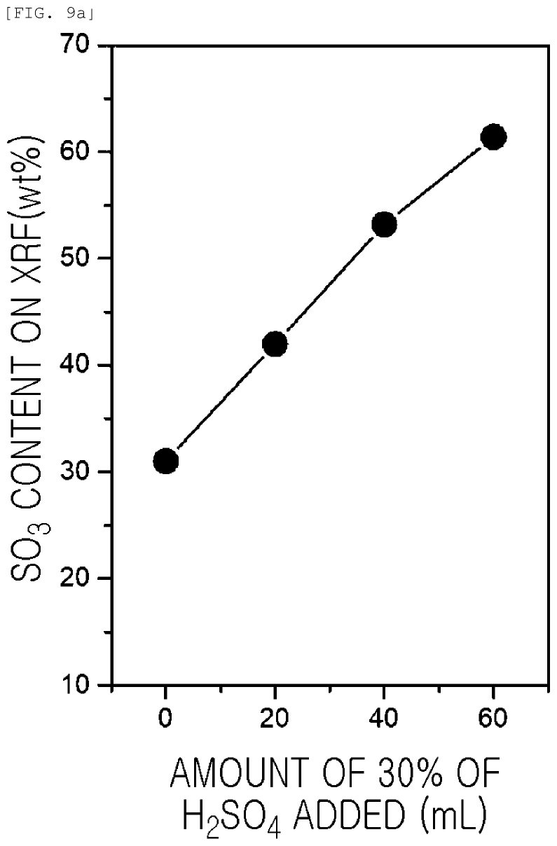

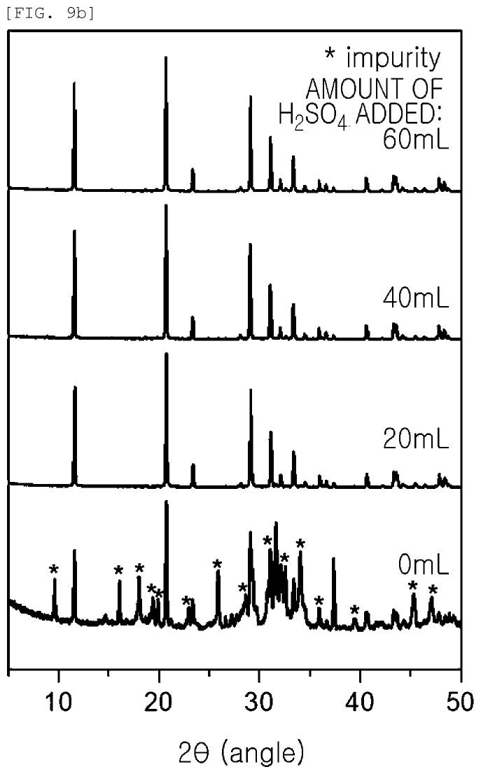

20, 40, 60, and 80 ml of 30 wt % sulfuric acid were added in different amounts to a waste solution (80° C.) from which low-purity gypsum manufactured in Example 4 (40 mL of 7M quicklime slurry was added) and ammonia manufactured in Example 5 were recovered, and then agitated. The purity of gypsum was confirmed through a SO₃ content of XRF and XRD, and the results were illustrated in FIGS. 9A and 9B, respectively.

According to FIGS. 9A and 9B, it can be confirmed that high-purity gypsum (CaSO₄·2H₂O) can be obtained by adding sulfuric acid to low-purity gypsum and agitating the same.

While this disclosure includes specific examples, it will be apparent to one of ordinary skill in the art that various changes in form and details may be made in these examples without departing from the spirit and scope of the claims and their equivalents.

1. A method for manufacturing sodium bicarbonate and gypsum, comprising:
a first solid-liquid separation operation for producing a sodium sulfate solution containing sodium ions from a mixture of an eluent and a sodium sulfate-containing material, and recovering the sodium sulfate solution;
a second solid-liquid separation operation for producing sodium bicarbonate (NaHCO₃) by adding carbon dioxide and ammonia to the sodium sulfate solution, and recovering the sodium bicarbonate;
a third solid-liquid separation operation for producing low-purity gypsum having an SO₃ content of less than 40 wt % by adding a calcium-containing material to the filtrate remaining after the sodium bicarbonate is recovered, and recovering the low-purity gypsum;
an ammonia recovery operation for producing ammonia by heating the filtrate remaining after the low-purity gypsum is recovered, and recovering the ammonia; and
a high-purity gypsumization operation for adding sulfuric acid and the low-purity gypsum recovered from the third solid-liquid separation operation to the filtrate remaining after the ammonia is recovered.

2. The method for manufacturing sodium bicarbonate and gypsum of claim 1, wherein an operation for recovering high-purity gypsum having an SO₃ content of 40 wt % or more is additionally performed following the high-purity gypsumization operation.

3. The method for manufacturing sodium bicarbonate and gypsum of claim 1, wherein a mass ratio of the sodium sulfate-containing material and the eluent added in the first solid-liquid separation operation is 1:1.4 to 1:3.

4. The method for manufacturing sodium bicarbonate and gypsum of claim 1, wherein a molar ratio of ammonia (NH₃)/sodium (Na⁺) in the second solid-liquid separation operation is 0.8 to 1.3.

5. The method for manufacturing sodium bicarbonate and gypsum of claim 1, wherein a pH in the second solid-liquid separation operation is maintained at 7.5 to 9.0.

6. The method for manufacturing sodium bicarbonate and gypsum of claim 1, wherein the second solid-liquid separation operation further comprises a sodium bicarbonate washing operation for washing the sodium bicarbonate to increase a recovery rate of the sodium bicarbonate.

7. The method for manufacturing sodium bicarbonate and gypsum of claim 6, wherein a washing solution used in the sodium bicarbonate washing operation is recycled as the eluent in the first solid-liquid separation operation.

8. The method for manufacturing sodium bicarbonate and gypsum of claim 6, further comprising, after the sodium bicarbonate washing operation:
a sodium bicarbonate drying operation for drying the sodium bicarbonate.
